(19) United States
(12) Patent Application Publication
(10) Pub. No.: US 2013/0071006 A1
(43) Pub. Date: Mar. 21, 2013

(54) Image Analysis of Processor Device Features

(71) Applicant: Dongbing Shao, Wappingers Falls, NY (US)

(72) Inventor: Dongbing Shao, Wappingers Falls, NY (US)

(73) Assignee: INTERNATIONAL BUSINESS MACHINES CORPORATION, Armonk, NY (US)

(21) Appl. No.: 13/235,841

(22) Filed: Sep. 19, 2011

(51) Int. Cl. G06K 9/52; G06K 9/46; G06K 9/00

(52) U.S. Cl. 382/141; 382/192; 382/199

(57) ABSTRACT

A method includes receiving an image of a scan area that includes a feature of interest, receiving and analyzing a design specification for features in the scan area, generating an intensity graph corresponding to a portion of the image, calculating with a processor, slopes of portions of the intensity graph to identify the feature of interest, applying portions of the design specification to the intensity graph to identify peaks that correspond to edges of the feature of interest, applying a logical function to the identified peaks to calculate a distance between the identified peaks, determining whether the calculated distance is within tolerances of the design specification, and outputting an error indication to a display responsive to determining that the calculated distance is not within tolerances of the design specification.

### BACKGROUND

The present invention relates to metrology, and more specifically, to measuring features of a processor device from an image of the processor device.

Processors such as, microprocessors that include semiconductor devices include features such as, for example, conductive connecting lines and field effect transistor devices. In fabrication, it is desirable to measure dimensions of the features to ensure that the features have been fabricated within design specifications.

One method for measuring the features of a processor device includes taking an image of the features with for example, a scanning electron microscope, or other type of imaging device, and measuring dimensions of portions of the feature found on the image. In this regard, the image is often a grayscale image having pixels with a variety of grey scale levels that represent the intensity of emitted charges for a particular portion of the processor device. Different features and portions of the features of the processor device emit varying intensities of charges that correspond to different grey scale levels in the image. For a given row or rows of pixels in the image, the intensity of each pixel in the row may be plotted on an intensity graph, where the horizontal axis of the graph represents the position of a particular pixel in the row and the vertical axis of the graph represents the intensity of the pixel in the position. Peak portions of the plotted graph represent higher intensity pixels that are often found at edges of features in the processor device. Thus, by measuring a distance between the peaks of a graph, one may calculate the distance between features or the dimensions of features that are shown on the image. Often processor implemented algorithms and logic are used to process an image, locate a feature of interest and measure a dimension of the feature of interest or a distance between particular features of interest.

### BRIEF SUMMARY

According to one embodiment of the present invention, a method includes receiving an image of a scan area that includes a feature of interest, receiving and analyzing a design specification for features in the scan area, generating an intensity graph corresponding to a portion of the image, calculating with a processor, slopes of portions of the intensity graph to identify the feature of interest, applying portions of the design specification to the intensity graph to identify peaks that correspond to edges of the feature of interest, applying a logical function to the identified peaks to calculate a distance between the identified peaks, determining whether the calculated distance is within tolerances of the design specification, and outputting an error indication to a display responsive to determining that the calculated distance is not within tolerances of the design specification.

According to another embodiment of the present invention a system includes a memory and a processor operative to receive an image of a scan area that includes a feature of interest, from the memory, receive and analyze a design specification for features in the scan area, generate an intensity graph corresponding to a portion of the image, calculate with a processor, slopes of portions of the intensity graph to identify the feature of interest, apply portions of the design specification to the intensity graph to identify peaks that correspond to edges of the feature of interest, apply a logical function to the identified peaks to calculate a distance between the identified peaks, determine whether the calculated distance is within tolerances of the design specification, and output an error indication to a display responsive to determining that the calculated distance is not within tolerances of the design specification.

According to yet another embodiment of the present invention a non-transitory computer-readable storage medium including computer executable instructions that, when executed on a processor of a computer apparatus, direct the processor to perform a method for measuring a feature of interest, the method includes receiving an image of a scan area that includes a feature of interest, receiving and analyzing a design specification for features in the scan area, generating an intensity graph corresponding to a portion of the image, calculating with a processor, slopes of portions of the intensity graph to identify the feature of interest, applying portions of the design specification to the intensity graph to identify peaks that correspond to edges of the feature of interest, applying a logical function to the identified peaks to calculate a distance between the identified peaks, determining whether the calculated distance is within tolerances of the design specification, and outputting an error indication to a display responsive to determining that the calculated distance is not within tolerances of the design specification.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates an exemplary embodiment of a system.

FIG. 2 illustrates a side cross-sectional view of an example of features that have been fabricated on a substrate.

FIG. 3 illustrates a block diagram of an exemplary method that may be implemented by the system.

FIG. 4A illustrates an example image of a line feature that is formed on a substrate.

FIG. 4B illustrates a stylized side cut-away view of the line feature.

FIG. 5 graphically illustrates a filter on an image.

FIG. 6 illustrates an image that includes a number of high intensity regions.

FIG. 7 illustrates an expanded view of the region 7 of FIG. 6.

FIG. 8 illustrates a graphical portion of a design specification and a corresponding image.

### DETAILED DESCRIPTION

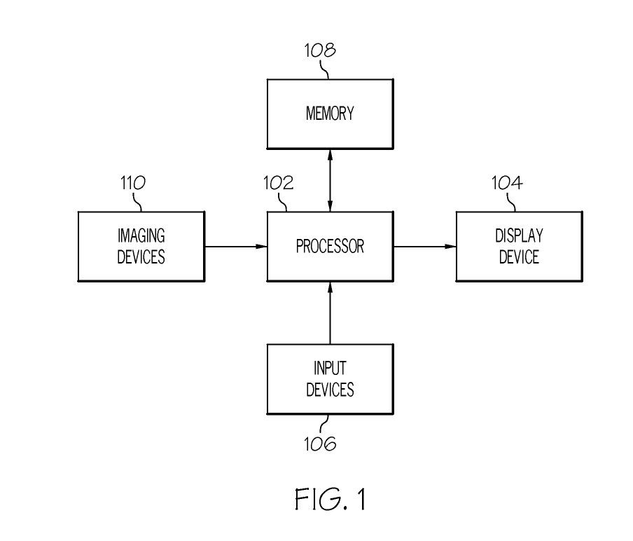

FIG. 1 illustrates an exemplary embodiment of a system 100 that includes a processor 102 that is communicatively connected to a display device 104, input device 106, a memory 108, and imaging devices 110. In the illustrated embodiment, the imaging devices 110 may include, for example, a scanning electron microscope (SEM) or other type of imaging device that is operative to capture an image of an object and output the image of the object to the processor 102. The processor 102 is operative to process the image using logic to measure, analyze or compare received images. In alternate embodiments, the processor 102 may not be connected to the imaging device 110, but may receive images from another source such as, for example, a data file stored in the memory 108. The processor 102 may output results of the image analysis process to a user on the display device 104, and/or output the results of the image analysis and/or control signals corresponding to the results of the image analysis to another system (not shown) that may be operative to control a device fabrication process.

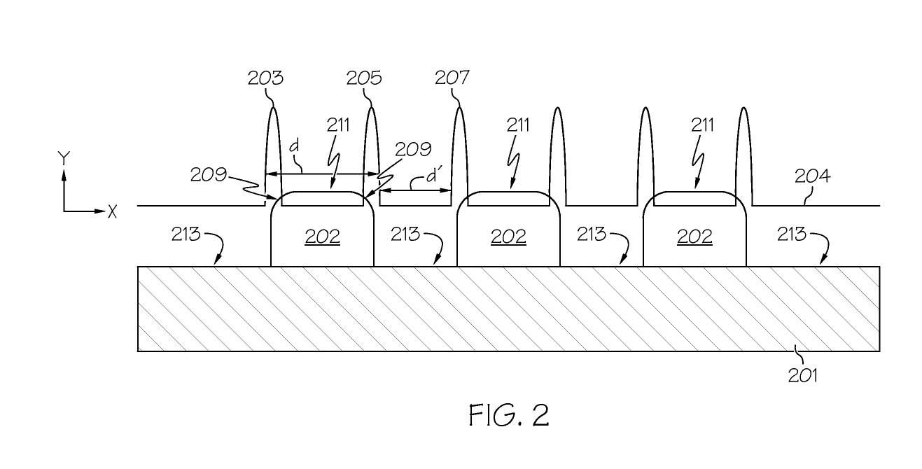

FIG. 2 illustrates a side cross-sectional view of an example of features 202 that have been fabricated on a substrate 201. A plotted graph 204 has been overlaid on the features 202 that represents the intensity (grayscale or color value) of a row of pixels of an example image (not shown) of the features 202. The horizontal axis of the plotted graph 204 represents the position of the pixels in the image and corresponds to positions along a corresponding line that may be laid across the features 202. The vertical axis of the plotted graph 204 represents the intensity (grayscale or color value) of the corresponding pixels. In the illustrated example, the rounded edges 209 of each of the features results in a higher pixel intensity than the horizontal portions 211 of the features 202 and the horizontal portions 213 of the substrate 201, and thus, a peak on the plotted graph 204 may be used to identify the edges 209 of the features 202. The position of the peaks may be used to determine a dimension of the features. For example, the distance (d) represents the width (i.e., the distance between the edges of the feature) of one of the features 202, and may be measured by calculating the distance between the peaks 203 and 205 of the plotted graph 204. The distance (d′) represents the width of a gap 206 (i.e., the distance between two of the features 202) that may be measured by calculating the distance between the peaks 205 and 207 of the plotted graph 204. The illustration of FIG. 2 represents a stylized example of a plotted graph 204, however in practice, the plotted graph 204 may include a variety of different peaks of varying intensities that may be caused by signal noise, image variations or distortions, clutter in the image, irregularities in the features, or irregularities in the image. The methods and systems described herein, include logic and functions that may be used with the processor 102 (of FIG. 1) to process an image, identify features of interest in the image, measure dimensions of the features of interest while accommodating a plotted graph that may include a variety of peaks of varying intensities, slopes, spacing, and widths that may be result from the causes described above.

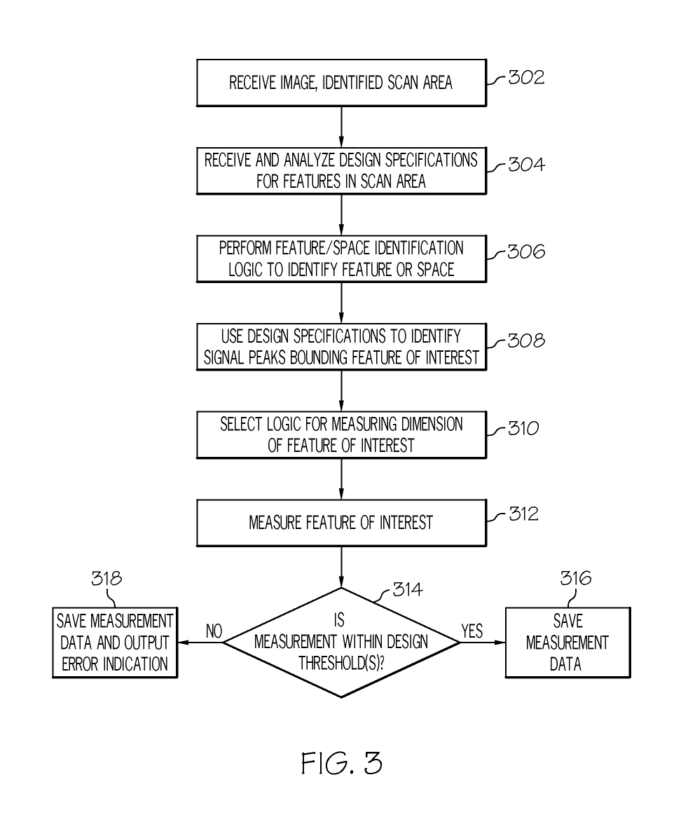

In this regard, FIG. 3 illustrates a block diagram of an exemplary method that may be implemented by the system 100 (of FIG. 1). In block 302 an image is received by the processor 102. In the illustrated embodiment the image includes a SEM image of a portion of a processor device. However, the embodiments described herein may be used for any type of image of any type of object. The scan area is identified by using design information such as pitch to compare and analize the image with the design to identify the scan area. In block 304 design specifications of features in the scan area are received by the processor 102, and the design specifications are processed for the scan area.

In this regard, the design specifications may include the designed or intended locations, shapes, and dimensions of features that are captured in the image. The design specifications are used to fabricate the features, and thus, the image of the features should ideally match the design specifications. However, in practice the features themselves may not match the design specifications, or errors, distortions, disorientation, or noise in the image may result in an image that does not match the design specifications. The design specifications may be processed to, for example, to identify a feature in the captured image that corresponds to a feature in the design specifications.

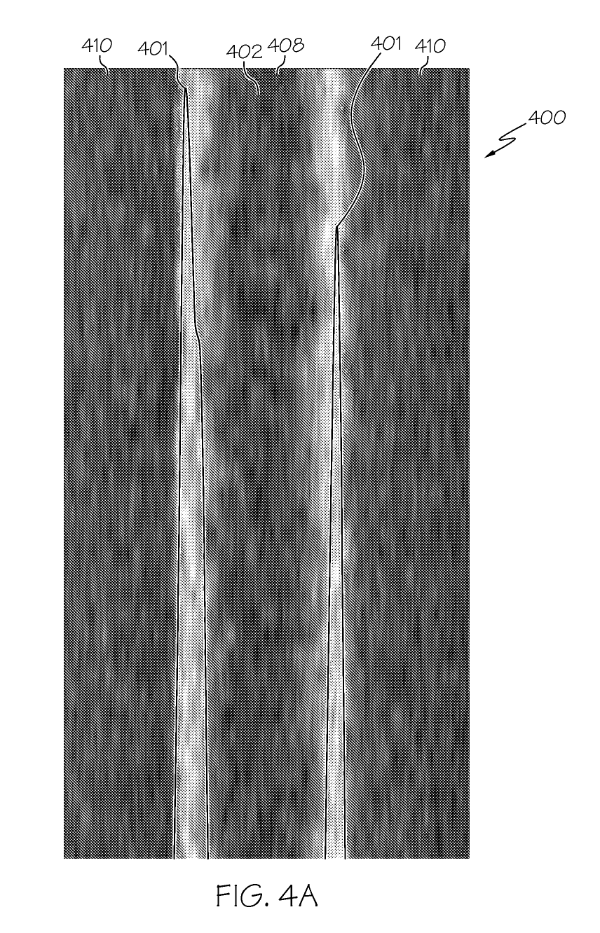

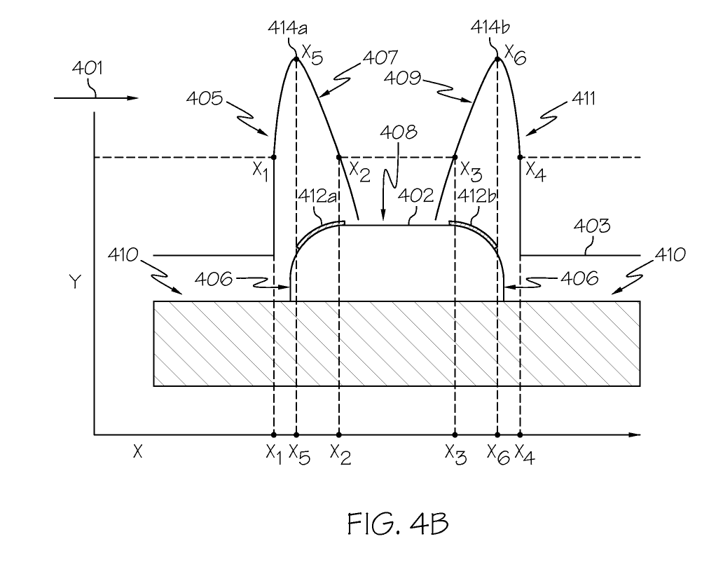

In block 306, the image is processed to identify a feature or a space. Referring to FIGS. 4A and 4B, FIG. 4A illustrates an example image 400 of a line feature 402 that is formed on a substrate. The line feature 404 is a linear feature having substantially vertical or sloped side walls 406 and a curved or substantially horizontal top surface 408. A substantially horizontal substrate surface (space region) 410 is shown on opposing sides of the line feature 402. The substrate surface 410 may be referred to as a space (i.e., a space between features). FIG. 4B illustrates a stylized side cut-away view of the line feature 402. The line feature 402 includes curved edges 412 at the transitions between the side walls 406 and the top surface 408. The curved edges 412 have a greater intensity in the image 400 and are illustrated by the lines of lighter shaded pixels in the image 400. The intensity of a row of pixels is plotted in the overlaid intensity graphs of FIGS. 4A and 4B. The intensity graph 403 of FIG. 4A represents an actual example of the intensity of a row of pixels in the image 400, while the intensity graph 403 of FIG. 4B represents a stylized intensity graph for exemplary purposes.

To identify a line or space feature, the intensity graph is processed or analyzed by the processor 102 (of FIG. 1). In this regard, referring to FIG. 4B, the intensity graph 403 includes peaks 414a and 414b that correspond to the edges 412a and 412b of the line feature 402. Moving along the intensity graph from left to right (as illustrated by the arrow 401), the slope of the peak 414a is positive in the region 405 closer to the space region 410 and negative in the region 407 closer to the top surface 408 of the line feature 402. The magnitude of the positive slope is greater than the magnitude of the negative slope. Similarly, the slope of the peak 414b is positive in the region 409 closer to the top surface 408 of the features 202 and negative in the region 411 closer to the space region 410. The magnitude of the positive slope is less than the magnitude of the negative slope. The intensity graph 403 may be represented as a function f(x) thus, by taking the derivative of the function f′(x) and calculating the slope of points along the x-axis, the differences magnitudes and the signs (i.e., positive or negative) of the slopes may be used to correlate the peaks of the intensity graph 403 with the features of the image, where the edges of a feature correspond to peaks on the intensity graph. Thus, for adjacent peaks each having a positive slope region and a negative slope region on the intensity graph, the edges or boundaries of a feature may be correlated to the peaks by identifying the relative magnitudes of the positive slope region and the negative slope region of each peak. FIG. 4B includes points x₁, x₂, x₃, and x₄ on peaks of the intensity graph (f(x)) 403, where when x₁<x₂<x₃<x₄, and |f(x₁)|>|f′(x₂)| and |f′(x₃)|<|f′(x₄)| the peaks (f′(x₅)=0 and f′(x₆)=0, where x₁<x₅<x₂ and x₃<x₆<x₄) correlate to edges of a feature on the image. The region between x₅ and x₆ corresponds to the top surface 408 of the feature and the region less than x₅ and the region greater than x₆ each correspond to one of the space regions 410.

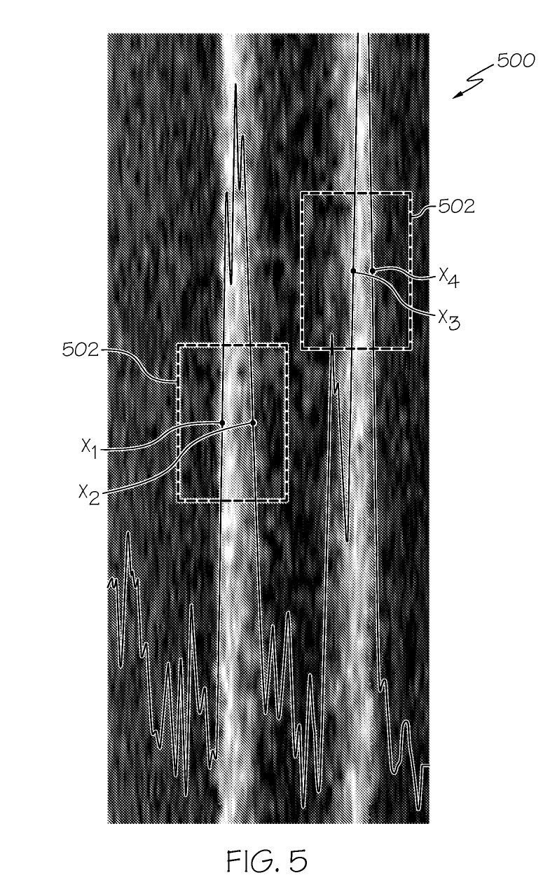

FIG. 5 graphically illustrates the a filter on an image 500 that may be used to filter regions of the intensity graph to avoid peaks that may not correspond to edges of a feature captured in the image 500. In this regard, the image 500 is similar to the image 400 (of FIG. 4) described above. The boxes 502 illustrates regions of the intensity graph 504 that are filtered from the rest of the intensity graph such that the slopes of points in the boxes 502 may be analyzed as described above. Thus, the points x₁, x₂, x₃, and x₄ (not shown) would lie in the boxes 502.

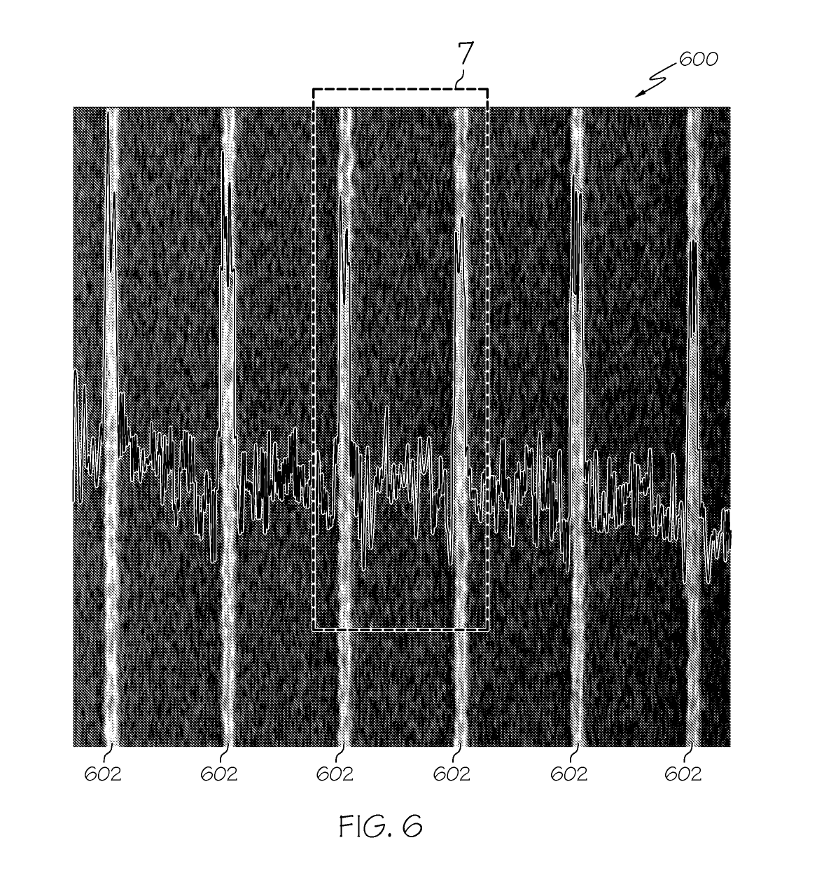

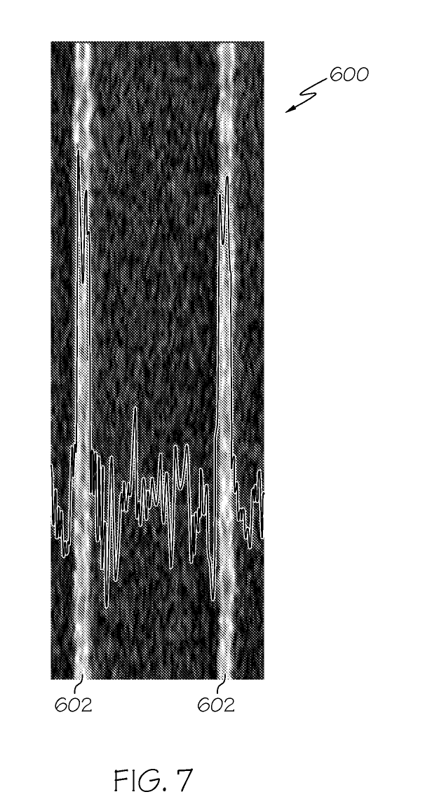

Referring to FIG. 3, in block 308 the design specifications are used to identify signal peaks bounding a feature of interest (target feature). In this regard, there are a number of methods that may be used alone or together with each other or with the line space identification logic described above to assist in identifying signal peaks bounding a feature of interest. For example, the design specifications may include a pitch or scale for the feature of interest. Thus when a feature of interest is a line, for example, and the linewidth is small, the peaks of the intensity graph that correlate to the edges of the feature will be closer together along the horizontal axis than when the linewidth is relatively larger. By determining the pitch of the feature of interest, the processor 102 may use logic to predict a range of distances that the identified peaks should fall between. FIG. 6 illustrates an image 600 that includes a number of high intensity regions 602. In the image, each region 602 is a line feature having a small width, however, without knowing the pitch, the processor 102 may incorrectly identify two adjacent high intensity regions 602 as being edges of a feature. FIG. 7 illustrates an expanded view of the region 7 (of FIG. 6) and shows how the overlaid intensity graph for each region 602 includes two peak regions that may be used to identify the edges of the features using methods similar to the methods described above. The implementation of the use of pitch to assist in identifying features may be described using the example of FIG. 4B. In this regard, the pitch of the feature retrieved from the design specifications may be used to identify the right pair of peaks and proper CD extraction algorithm to use as well. Thus, the processor 102 may calculate the distance (t) where t=x₆-x₅ and determine whether t is close to the design target within certain tolerance. If no, the processor 102 concludes that the peaks do not correspond to one feature but may correlate to two features having a small linewidth. Thus, the processor 102 may adjust the logic function that identifies the peaks to identify peaks at a lower scale or pitch (i.e., pairs of peaks that are closer together or have at less than tₜₕ).

Another method that may be used in addition to or independently from the pitch in the design specifications to assist in identifying signal peaks bounding a feature of interest is the analysis of the design specifications to identify a number of features that should be present in the image. For example, referring to FIG. 6, the image includes six features, thus, the intensity graph should include two peaks corresponding to the two edges of each feature and twelve peaks total. If the processor 102 (of FIG. 1) analyzes the intensity graph and identifies only six peaks, the subsequent measurements would be incorrect since the measurements would not have measured the distances between the edges of an object. Thus, the analysis of the design specifications may identify the number of features that are present in an image. The number of features (w) may be compared to the number of identified peaks (p) where w should equal p/2. If w does not equal p/2, the processor 102 should adjust all available logic functions to identify the correct number of features from tool that matches the design specification.

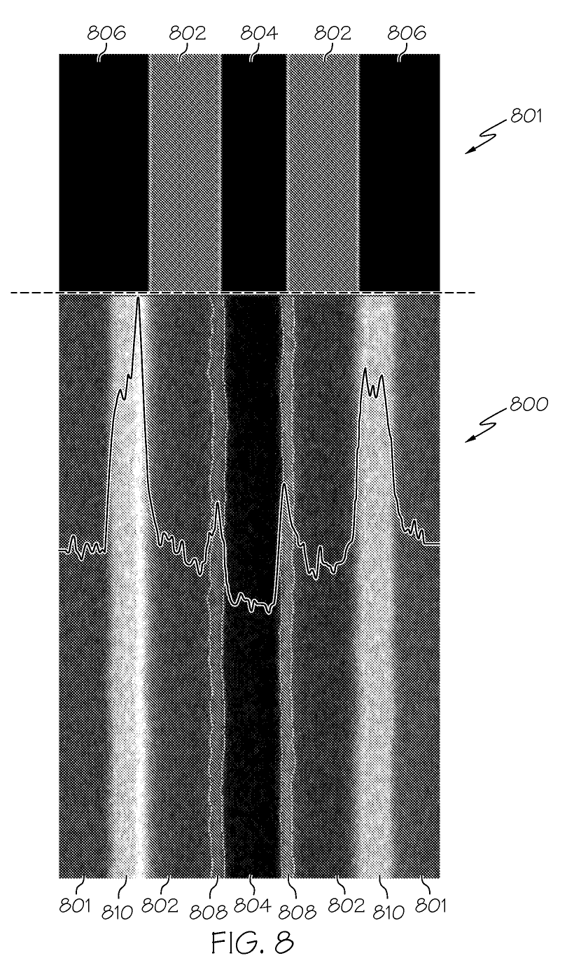

Below is another example of method to assist in identifying signal peaks bounding a feature of interest that may be used in addition to or independent from the methods described above. FIG. 8 illustrates a graphical portion of a design specification 801 and a corresponding image 800. Features 802 are arranged with a space region 804 disposed between the features 802 and space regions 806 disposed on sides of the features 802 opposing the space regions 804. The corresponding image 800 includes higher intensity regions 808 that are adjacent to the space region 804 and relatively wide higher intensity regions 810 that are adjacent to the space regions 806. The higher intensity regions 808 and 810 correspond to edges of the features 802. The relative width and relative intensity higher regions 810 indicate that the edges of the features 802 that correspond with the higher intensity regions 810 have a more gradual slope or curved profile than the opposing edges corresponding to the higher intensity regions 808, which have a more acute or vertical profile. The differences between the profiles of the edges is caused by the etching process used to fabricate the features 802 and the distance between the edges of each feature 802 and other features. When features are relatively close together (i.e., there is less space between adjacent edges of the features), a dry etching process such as, for example, reactive ion etching (RIE) tends to define the edges of the features with a greater slope or gradient. Conversely, when an edge of a feature is adjacent to a large space region such as the space regions 806, the edge of the feature is formed with a more gradual slope or profile as shown by the width and intensities of the higher intensity regions 810. The gradients or slopes and the corresponding intensity graphs for the features may be predicted by determining a distance between the features in the design specification 801. By analyzing the design specification 801 to calculate or predict corresponding widths and intensities of the peaks in the intensity graph based upon the distances between the edges of the features and other features, the processor 102 may use logic to adjust the function used to identify peaks that correlate with a feature of interest.

Referring back to FIG. 3, in block 310 the logic used for measuring a dimension of a feature of interest is selected. The logic may include a function or algorithm that is associated with or has been tailored based on the results of one or more of the peak identification methods described above. In block 312, the feature of interest is measured by, for example, calculating a distance between the identified peaks. In block 314 the value of the measurement is compared with a target value(s) to determine whether the value of the measurement is within design specification tolerances. If yes, the measurement data may be saved in the memory 108 (of FIG. 1) in block 316. If no, the measurement data may be saved in the memory 108 and an indication that the measurement is not within specification (an error indication) may be output to the display device 104.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method comprising:
receiving an image of a scan area that includes a feature of interest;
receiving and analyzing a design specification for features in the scan area;
generating an intensity graph corresponding to a portion of the image;
calculating with a processor, slopes of portions of the intensity graph to identify the feature of interest;
applying portions of the design specification to the intensity graph to identify peaks that correspond to edges of the feature of interest;
applying a logical function to the identified peaks to calculate a distance between the identified peaks;
determining whether the calculated distance is within tolerances of the design specification; and
outputting an error indication to a display responsive to determining that the calculated distance is not within tolerances of the design specification.

2. The method of claim 1, wherein the applying portions of the design specification to the intensity graph to identify peaks that bound the feature of interest comprises:
calculating a value of the distance between peaks of the intensity graph;
determining whether a difference between the value of the distance between the peaks and a value defined by a function of a pitch value associated with the feature of interest is greater than a threshold value, wherein a portion of the design specification includes the pitch value; and
designating the peaks of the intensity graph as identified peaks responsive to determining that the difference between the value of the distance between the peaks and a value defined by a function of the pitch value associated with the feature of interest is not greater than the threshold value.

3. The method of claim 1, wherein the applying portions of the design specification to the intensity graph to identify peaks that bound the feature of interest comprises:
calculating a number of features in a region of the design specification corresponding to the scan area;
calculating a number of peaks in the intensity graph above a threshold intensity;
determining whether the number of peaks corresponds to the number of features in the region of the design specification corresponding to the scan area; and
designating peaks of the intensity graph as identified peaks responsive to determining that the number of peaks corresponds to the number of features in the region of the design specification corresponding to the scan area.

4. The method of claim 1, wherein the applying portions of the design specification to the intensity graph to identify peaks that bound the feature of interest comprises:
identifying edges of a feature of the design specification that when fabricated will include a shallow slope profile resulting from an etching process;
correlating the identified edges with peaks in the intensity graph having a relatively large width; and
designating correlated peaks of the intensity graph as identified peaks.

5. The method of claim 1, wherein the calculating with a processor, slopes of portions of the intensity graph to identify the feature of interest comprises:
identifying a first peak and a second peak in the intensity graph;
calculating a slope of a first portion of a first peak and a slope of a second portion of the first peak, wherein the slope of the first portion of the first peak is positive and the slope of the second portion of the first peak is negative;
calculating a slope of a first portion of the second peak and a slope of a second portion of the first peak, wherein the slope of the first portion of the second peak is positive and the slope of the second portion of the second peak is negative;
determining whether a magnitude of the slope of the first portion of the first peak is greater then the magnitude of the slope of the second portion of the first peak;
determining whether a magnitude of the slope of the first portion of the second peak is less than the magnitude of the slope of the second portion of the second peak;
identifying the feature interest responsive to determining that the magnitude of the slope of the first portion of the first peak is greater then the magnitude of the slope of the second portion of the first peak and that the magnitude of the slope of the first portion of the second peak is less than the magnitude of the slope of the second portion of the second peak.

6. The method of claim 1, wherein the design specification includes a graphical representation of the scan area.

7. A system comprising:
a memory; and
a processor operative to receive an image of a scan area that includes a feature of interest, from the memory, receive and analyze a design specification for features in the scan area, generate an intensity graph corresponding to a portion of the image, calculate with a processor, slopes of portions of the intensity graph to identify the feature of interest, apply portions of the design specification to the intensity graph to identify peaks that correspond to edges of the feature of interest, apply a logical function to the identified peaks to calculate a distance between the identified peaks, determine whether the calculated distance is within tolerances of the design specification, and output an error indication to a display responsive to determining that the calculated distance is not within tolerances of the design specification.

8. The system of claim 7, wherein the applying portions of the design specification to the intensity graph to identify peaks that bound the feature of interest comprises:
calculating a value of the distance between peaks of the intensity graph;
determining whether a difference between the value of the distance between the peaks and a value defined by a function of a pitch value associated with the feature of interest is greater than a threshold value, wherein a portion of the design specification includes the pitch value; and
designating the peaks of the intensity graph as identified peaks responsive to determining that the difference between the value of the distance between the peaks and a value defined by a function of the pitch value associated with the feature of interest is not greater than the threshold value.

9. The system of claim 7, wherein the applying portions of the design specification to the intensity graph to identify peaks that bound the feature of interest comprises:
calculating a number of features in a region of the design specification corresponding to the scan area;
calculating a number of peaks in the intensity graph above a threshold intensity;
determining whether the number of peaks corresponds to the number of features in the region of the design specification corresponding to the scan area; and
designating peaks of the intensity graph as identified peaks responsive to determining that the number of peaks corresponds to the number of features in the region of the design specification corresponding to the scan area.

10. The system of claim 7, wherein the applying portions of the design specification to the intensity graph to identify peaks that bound the feature of interest comprises:
identifying edges of a feature of the design specification that when fabricated will include a shallow slope profile resulting from an etching process;
correlating the identified edges with peaks in the intensity graph having a relatively large width; and
designating correlated peaks of the intensity graph as identified peaks.

11. The system of claim 7, wherein the calculating with a processor, slopes of portions of the intensity graph to identify the feature of interest comprises:
identifying a first peak and a second peak in the intensity graph;
calculating a slope of a first portion of a first peak and a slope of a second portion of the first peak, wherein the slope of the first portion of the first peak is positive and the slope of the second portion of the first peak is negative;
calculating a slope of a first portion of the second peak and a slope of a second portion of the first peak, wherein the slope of the first portion of the second peak is positive and the slope of the second portion of the second peak is negative;
determining whether a magnitude of the slope of the first portion of the first peak is greater then the magnitude of the slope of the second portion of the first peak;
determining whether a magnitude of the slope of the first portion of the second peak is less than the magnitude of the slope of the second portion of the second peak;
identifying the feature interest responsive to determining that the magnitude of the slope of the first portion of the first peak is greater then the magnitude of the slope of the second portion of the first peak and that the magnitude of the slope of the first portion of the second peak is less than the magnitude of the slope of the second portion of the second peak.

12. The system of claim 7, wherein the design specification includes a graphical representation of the scan area.

13. A non-transitory computer-readable storage medium including computer executable instructions that, when executed on a processor of a computer apparatus, direct the processor to perform a method for measuring a feature of interest, the method comprising:
receiving an image of a scan area that includes a feature of interest;
receiving and analyzing a design specification for features in the scan area;
generating an intensity graph corresponding to a portion of the image;
calculating with a processor, slopes of portions of the intensity graph to identify the feature of interest;
applying portions of the design specification to the intensity graph to identify peaks that correspond to edges of the feature of interest;
applying a logical function to the identified peaks to calculate a distance between the identified peaks;
determining whether the calculated distance is within tolerances of the design specification; and
outputting an error indication to a display responsive to determining that the calculated distance is not within tolerances of the design specification.

14. The method of claim 13, wherein the applying portions of the design specification to the intensity graph to identify peaks that bound the feature of interest comprises:
calculating a value of the distance between peaks of the intensity graph;
determining whether a difference between the value of the distance between the peaks and a value defined by a function of a pitch value associated with the feature of interest is greater than a threshold value, wherein a portion of the design specification includes the pitch value; and
designating the peaks of the intensity graph as identified peaks responsive to determining that the difference between the value of the distance between the peaks and a value defined by a function of the pitch value associated with the feature of interest is not greater than the threshold value.

15. The method of claim 13, wherein the applying portions of the design specification to the intensity graph to identify peaks that bound the feature of interest comprises:
calculating a number of features in a region of the design specification corresponding to the scan area;
calculating a number of peaks in the intensity graph above a threshold intensity;
determining whether the number of peaks corresponds to the number of features in the region of the design specification corresponding to the scan area; and
designating peaks of the intensity graph as identified peaks responsive to determining that the number of peaks corresponds to the number of features in the region of the design specification corresponding to the scan area.

16. The method of claim 13, wherein the applying portions of the design specification to the intensity graph to identify peaks that bound the feature of interest comprises:
identifying edges of a feature of the design specification that when fabricated will include a shallow slope profile resulting from an etching process;
correlating the identified edges with peaks in the intensity graph having a relatively large width; and
designating correlated peaks of the intensity graph as identified peaks.

17. The method of claim 13, wherein the calculating with a processor, slopes of portions of the intensity graph to identify the feature of interest comprises:
identifying a first peak and a second peak in the intensity graph;
calculating a slope of a first portion of a first peak and a slope of a second portion of the first peak, wherein the slope of the first portion of the first peak is positive and the slope of the second portion of the first peak is negative;
calculating a slope of a first portion of the second peak and a slope of a second portion of the first peak, wherein the slope of the first portion of the second peak is positive and the slope of the second portion of the second peak is negative;
determining whether a magnitude of the slope of the first portion of the first peak is greater then the magnitude of the slope of the second portion of the first peak;
determining whether a magnitude of the slope of the first portion of the second peak is less than the magnitude of the slope of the second portion of the second peak;
identifying the feature interest responsive to determining that the magnitude of the slope of the first portion of the first peak is greater then the magnitude of the slope of the second portion of the first peak and that the magnitude of the slope of the first portion of the second peak is less than the magnitude of the slope of the second portion of the second peak.

18. The method of claim 13, wherein the design specification includes a graphical representation of the scan area.
